(19) United States
(12) Patent Application Publication
(10) Pub. No.: US 2025/0298860 A1
(43) Pub. Date: Sep. 25, 2025

(54) INFORMATION PROCESSING DEVICE, INFORMATION PROCESSING METHOD, AND COMPUTER PROGRAM PRODUCT

(71) Applicants: KABUSHIKI KAISHA TOSHIBA, Tokyo (JP); TOSHIBA DIGITAL SOLUTIONS CORPORATION, Kawasaki-shi Kanagawa (JP)

(72) Inventors: Shun OKUNO, Chofu Tokyo (JP); Shunji TESHIMA, Hino Tokyo (JP); Yasuichiro IZUMI, Fuchu Tokyo (JP)

(73) Assignees: KABUSHIKI KAISHA TOSHIBA, Tokyo (JP); TOSHIBA DIGITAL SOLUTIONS CORPORATION, Kawasaki-shi Kanagawa (JP)

(21) Appl. No.: 19/075,533

(22) Filed: Mar. 10, 2025

(30) Foreign Application Priority Data
Mar. 22, 2024 (JP) 2024-047136

(51) Int. Cl. G06F 17/11

(52) U.S. Cl. CPC G06F 17/11

(57) ABSTRACT

An information processing device includes an optimization unit, a control unit, and a search unit. The optimization unit executes optimization calculation processing of obtaining an optimal solution by repeatedly executing solving processing of obtaining a solution to an optimization problem by using one or more set parameters. The control unit sets a calculation time of the optimization calculation processing for each of a plurality of search times obtained by dividing a specified time that is specified. The search unit repeatedly executes search processing of setting the parameter different from parameters of other search times for each of the plurality of search times, causing the optimization unit to execute the optimization calculation processing within the set calculation time by using the set parameter, and searching for an optimal value of the parameter by Bayesian optimization by using the optimal solution obtained by the optimization calculation processing.

### CROSS-REFERENCE TO RELATED APPLICATIONS

This application is based upon and claims the benefit of priority from Japanese Patent Application No. 2024-047136, filed on Mar. 22, 2024; the entire contents of which are incorporated herein by reference.

### FIELD

An embodiment of the present disclosure relates to an information processing device, an information processing method, and a computer program product.

### BACKGROUND

As a technique of solving a combinatorial optimization problem or the like, an optimization technique using a simulated bifurcation machine (SBM), a quantum annealer, and the like is known. For such a technique, in order to obtain a better solution, search processing of searching for optimal values to be set for a plurality of parameters used for calculation may be performed.

### BRIEF DESCRIPTION OF THE DRAWINGS

FIG. 1 is a block diagram illustrating an example of a configuration of an information processing device of an embodiment;

FIG. 2 is a flowchart illustrating an example of information processing in the embodiment;

FIG. 3 is a flowchart illustrating an example of information processing in a first modification;

FIG. 4 is a flowchart illustrating an example of information processing in a second modification; and

FIG. 5 is an explanatory diagram illustrating a hardware configuration example of the information processing device.

### DETAILED DESCRIPTION

According to an embodiment, an information processing device includes one or more hardware processors configured to function as an optimization unit, a control unit, and a search unit. The optimization unit executes optimization calculation processing of obtaining an optimal solution by repeatedly executing solving processing of obtaining a solution to an optimization problem by using one or more set parameters. The control unit sets a calculation time of the optimization calculation processing for each of a plurality of search times obtained by dividing a specified time that is specified. The search unit repeatedly executes search processing of setting the parameter different from parameters of other search times for each of the plurality of search times, causing the optimization unit to execute the optimization calculation processing within the set calculation time by using the set parameter, and searching for an optimal value of the parameter by Bayesian optimization by using the optimal solution obtained by the optimization calculation processing.

Hereinafter, a preferred embodiment of an information processing device according to the present disclosure will be described in detail with reference to the accompanying drawings. The present disclosure is not limited to the following embodiments.

As search processing of searching for an optimal value of a parameter for optimization calculation processing, for example, a parameter search technique using Bayesian optimization has been proposed. In such a parameter search technique, “evaluation values (observation points)” for a “combination (point) of parameters of a calculation condition” are compared on the basis of an idea of the Bayesian optimization that “a good quality point is probabilistically searched from observation points”. Thereafter, the parameters of the calculation condition are updated according to an algorithm of the Bayesian optimization, and the evaluation values are acquired again. In a case where accuracy of calculation indicated by the evaluation values is increased, the parameters are updated, and in a case where the accuracy is not increased, the parameters are not updated. Such processing is repeatedly executed.

As the optimization calculation processing (calculation processing for solving an optimization problem), there has been proposed a technique of repeatedly executing calculation processing of obtaining a solution to the optimization problem (hereinafter, solving processing) within a given calculation time to update (converge) the solution so as to approach an optimal solution, and outputting the converged solution as the optimal solution. Hereinafter, an example of such optimization calculation processing will be described.
Optimization calculation processing using a simulated bifurcation machine
Optimization calculation processing using a quantum annealer (quantum annealing)

The parameter for the optimization calculation processing is searched for as follows, for example.
The search processing of updating the parameter and executing the optimization calculation processing is repeatedly executed.
In each search processing, the optimization calculation processing is executed using the updated parameter, and a solution to be evaluated (optimal solution) is obtained.
In one time of the optimization calculation processing (search processing), a plurality of times of the solving processing is repeatedly executed, and a converged solution is obtained as the solution to be evaluated (optimal solution).

An entire processing time including the plurality of times of search processing is calculated by, for example, the number of times of repetitions of the search processing×a calculation time per one time of the search processing. Therefore, in order to reduce the entire processing time and search for the parameter more efficiently, it is necessary to reduce the number of times of repetitions or the calculation time per one time.

In the parameter search technique using the Bayesian optimization, a probability that a good quality point (combination of parameters) can be obtained (accuracy of search) increases as the number of times of repetitions of the search processing increases. Furthermore, when the number of times of repetitions of the search processing is small, there is a possibility that an appropriate parameter cannot be searched for, and thus it may be undesirable to reduce the number of times of repetitions.

In the present embodiment, the search processing for the parameter using the Bayesian optimization is performed more efficiently within a limited time, and it is possible to search for the parameter that makes it possible to obtain a more accurate solution of the optimization calculation processing. In the present embodiment, the optimization calculation processing of obtaining a converged optimal solution by repeatedly executing the solving processing as described above is executed.

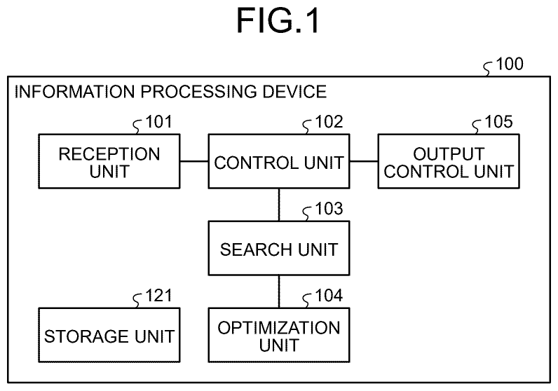

FIG. 1 is a block diagram illustrating an example of a configuration of an information processing device 100 of the embodiment. As illustrated in FIG. 1, the information processing device 100 includes a reception unit 101, a control unit 102, a search unit 103, an optimization unit 104, an output control unit 105, and a storage unit 121.

The reception unit 101 receives inputs of various types of information used in the information processing device 100. For example, the reception unit 101 receives calculation data used for optimization calculation processing by the optimization unit 104 and search processing by the search unit 103. The calculation data may be any data according to the optimization calculation processing and search processing to be applied, and examples of the calculation data include the following data.
Data determining an optimization problem (a constraint condition or the like)
Data to be an input of the optimization calculation processing
A parameter for the optimization calculation processing.
A parameter for the search processing

Examples of the parameter for the optimization calculation processing input as the calculation data include the following parameters.
A specified time representing an upper limit of an entire processing time of the optimization calculation processing
An upper limit (threshold TH_A) of the number of times of calculation of solving processing repeated in one time of the search processing

Note that the specified time (the entire processing time of the optimization calculation processing) is specified as, for example, an upper limit of a time for solving the optimization problem by a user. The present embodiment can be implemented as a mode in which the search processing (optimization calculation processing) is executed a plurality of times within the specified time, and an optimal solution to the optimization problem is obtained and output to a request source (user or the like) while obtaining an optimal value of the parameter. Although it can be interpreted that one time of the optimization calculation processing is instructed from the user, normally, the plurality of times of optimization calculation processing is executed inside the information processing device 100 according to the repetition of the search processing.

Examples of the parameter for the search processing include the following parameter.
An upper limit (threshold TH_B) of the number of times of repetitions of the search processing (the number of searches)

The reception unit 101 may execute verification of the received data, conversion of the received data, and the like. The verification of the data is, for example, processing of confirming whether the data is appropriate data to be subjected to the optimization calculation processing.

The control unit 102 controls the search processing for the parameter using the Bayesian optimization. For example, the control unit 102 creates a schedule of the search processing, and controls the search processing according to the schedule.

First, the control unit 102 divides the specified time specified by the user or the like into a plurality of search times. The search time corresponds not to a calculation time per one time of the search processing but to a time for repeatedly executing a plurality of times of the search processing. The number of divisions may be any value as long as it is two or more. Hereinafter, an example in which the specified time is divided into two search times will be mainly described.

The specified time is specified by, for example, a length of a time (for example, 10 seconds). The control unit 102 divides the specified time into the two search times according to, for example, a predetermined ratio. Hereinafter, an example in which the specified time is divided at a ratio of 1:1 will be described, but the ratio is not limited to 1:1 and may be any value.

In a case where 10 seconds are specified as the specified time, the control unit 102 divides the 10 seconds as the specified time into, for example, five seconds as a first half search time and five seconds as a second half search time. The first half search time and the second half search time correspond to an early search time (first search time) and a late search time (second search time), respectively. Hereinafter, the search time may be referred to as a phase, and the first half search time and the second half search time may be referred to as a first half phase and a second half phase, respectively.

Next, the control unit 102 sets a calculation time of the optimization calculation processing executed in the search processing for each of the plurality of search times (phases). For example, the control unit 102 sets a value of the calculation time to be smaller as the search time is earlier among the plurality of search times. In the case where the specified time is divided into the two search times (phases), the control unit 102 sets a value of the calculation time for the first half phase to be smaller than a value of the calculation time for the second half phase. For example, in a case where each of the first half phase and the second half phase is five seconds, the control unit 102 sets the calculation time of the optimization calculation processing of the first half phase to 0.1 seconds, and sets the calculation time of the optimization calculation processing of the second half phase to 2.5 seconds.

Dividing the specified time into the plurality of search times and setting the calculation time for each search time correspond to creating the schedule of the search processing. Note that an example of an effect obtained by setting the value of the calculation time to be smaller as the search time is earlier will be described later.

The search unit 103 executes the search processing for a parameter using the Bayesian optimization under the control of the control unit 102. For example, the search unit 103 sets mutually different parameters for the plurality of search times. The search unit 103 causes the optimization unit 104 to execute the optimization calculation processing using the set parameters so as to be completed within the set calculation time, and repeatedly executes the search processing using an optimal solution obtained by the optimization calculation processing.

Note that the parameter searched for using the Bayesian optimization is a parameter different from the parameter for the optimization calculation processing input as the calculation data. The parameter to be searched for is determined according to a type of the optimization calculation processing to be applied. For example, in a case where the optimization calculation processing using a simulated bifurcation machine is used, the following parameters correspond to the parameter to be searched for using the Bayesian optimization.
A time step width for the calculation
A coefficient for the constraint condition

The search unit 103 causes the optimization unit 104 to execute the optimization calculation processing so as to be completed within the set calculation time among the scheduled search times. For example, in a case where the first half phase is five seconds, the search unit 103 causes the optimization unit 104 to execute the optimization calculation processing so as to be completed within the calculation time of 0.1 seconds. In this case, the number of times of repetitions of the optimization calculation processing (search processing) is up to 50 (5/0.1). Furthermore, in a case where the second half phase is five seconds, the search unit 103 causes the optimization unit 104 to execute the optimization calculation processing so as to be completed within the calculation time of 2.5 seconds. In this case, the number of times of repetitions of the optimization calculation processing (search processing) is up to twice (5/2.5).

In addition to the number of times of repetitions obtained from the search time and the calculation time, a threshold (second threshold) representing the upper limit of the number of searches may be set. The threshold TH_B described above corresponds to the threshold in this case. For example, the search unit 103 ends the search processing even within the search time in a case where the number of times of repetitions of the search processing (the number of searches) in the search time reaches the threshold TH_B, and transitions to processing of the next phase in a case where there is the next phase (for example, the second half phase).

The threshold TH_B is, for example, a value predetermined as the number of searches that makes it possible to search for an appropriate parameter. By using the threshold TH_B, it is possible to suppress repetition of invalid search processing and to search for the parameter more efficiently. The threshold TH_B may be set to a different value for each of the plurality of search times.

The optimization unit 104 executes the optimization calculation processing according to an instruction from the search unit 103. For example, the optimization unit 104 executes the optimization calculation processing so as to be completed within the set calculation time by using one or more parameters set by the search unit 103. The optimization unit 104 outputs an optimal solution obtained within the set calculation time to the search unit 103.

The optimization unit 104 may end the optimization calculation processing in a case where the number of times of repetitions of the solving processing reaches a threshold (first threshold). The threshold TH_A described above corresponds to the threshold in this case. For example, in a case where the number of times of repetitions of the solving processing in the calculation time of the optimization calculation processing reaches the threshold TH_A, the optimization unit 104 ends the optimization calculation processing even within the calculation time.

The threshold TH_A is, for example, a value predetermined as the number of times of repetitions that makes it possible to obtain an appropriate optimal solution. By using the threshold TH_A, it is possible to suppress repetition of invalid solving processing and to search for the parameter more efficiently. The threshold TH_A may be set to a different value for each of the plurality of search times.

The optimization calculation processing by the optimization unit 104 may be parallelized and executed by a plurality of devices according to a specified degree of parallelism. In such a case, the degree of parallelism may be included in the parameter to be searched for.

The output control unit 105 controls outputs of various types of information used in the information processing device 100. For example, the output control unit 105 outputs an optimal solution obtained by the optimization unit 104 as a processing result. The output control unit 105 may output the processing result in a format that can be interpreted by the user or the like who has requested execution of the optimization calculation processing.

At least a part of the respective units (the reception unit 101, the control unit 102, the search unit 103, the optimization unit 104, and the output control unit 105) described above may be implemented by one or more processors. Each of the units described above is implemented by, for example, one or a plurality of processors. For example, each of the units described above may be implemented by causing a processor such as a central processing unit (CPU) and a graphics processing unit (GPU) to execute a program, that is, by software. Each of the units described above may be implemented by a processor such as a dedicated integrated circuit (IC), that is, hardware. Each of the units described above may be implemented by using the software and the hardware in combination. In a case where a plurality of processors is used, each processor may implement one of the units or two or more of the units.

The storage unit 121 stores various types of information used in the information processing device. For example, the storage unit 121 stores various types of the information (calculation data and the like) received by the reception unit 101 and information output in processing by each unit (intermediate data, a processing result, and the like).

Note that the storage unit 121 can be configured by any commonly used storage medium such as a flash memory, a memory card, a random access memory (RAM), a hard disk drive (HDD), and an optical disc.

The information processing device 100 may be physically configured by one device or may be physically configured by a plurality of devices. For example, the information processing device 100 may be constructed on a cloud environment. Furthermore, each unit in the information processing device 100 may be dispersedly included in a plurality of devices. For example, the optimization unit 104 may be included in a device (another cloud or the like) different from the other configurations.

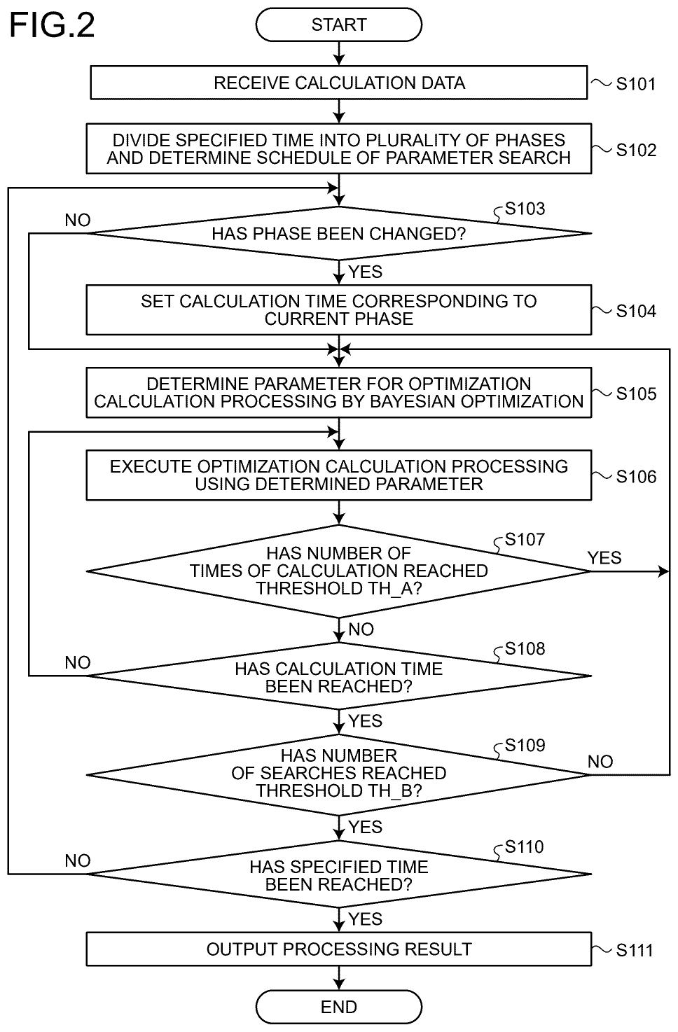

Next, information processing by the information processing device 100 of the embodiment will be described. The information processing is processing of obtaining an optimal solution to an optimization problem requested from a user or the like. In the information processing, while an optimal value of a parameter is searched for by the search processing, the optimal solution is calculated by the optimization calculation processing. FIG. 2 is a flowchart illustrating an example of the information processing in the embodiment.

The reception unit 101 receives calculation data input by a user or the like (step S101). The calculation data includes a specified time and the like as described above.

The control unit 102 divides the specified time into a plurality of phases and determines a schedule of parameter search (step S102). For example, the control unit 102 divides the specified time of 10 seconds into a first half phase of five seconds and a second half phase of five seconds.

The control unit 102 determines whether or not the phase has been changed (step S103). For example, the control unit 102 determines that the phase has been changed at the start of the first processing after the division into the plurality of phases or when the search time corresponding to each phase has elapsed.

In a case where the phase has been changed (step S103: Yes), the control unit 102 sets a calculation time corresponding to the current phase (changed phase) (step S104). For example, the control unit 102 sets the calculation time to 0.1 seconds in a case where the current phase is the first half phase, and sets the calculation time to 2.5 seconds in a case where the current phase is the second half phase.

After the calculation time is set (step S104) and in a case where the phase has not been changed (step S103: No), the control unit 102 causes the search unit 103 to execute search processing according to the determined schedule (search time) and the set calculation time (steps S105 to S109).

First, the search unit 103 determines a parameter for optimization calculation processing by Bayesian optimization (step S105). In the first time of repetition, the search unit 103 determines the parameter to an initial value (for example, a random value). In the second and subsequent times of the repetition, the parameter for the optimization calculation processing is updated using an evaluation value of an optimal solution obtained up to step S109, so that accuracy of the evaluation value increases according to the Bayesian optimization.

The optimization unit 104 executes the optimization calculation processing using the determined parameter (step S106). Note that steps S106 to S108 correspond to one time of processing of solving processing repeatedly executed in the optimization calculation processing. That is, steps S106 to S108 are repeatedly executed in the optimization calculation processing.

The optimization unit 104 determines whether or not the number of times of calculation in the repeatedly executed solving processing has reached the threshold TH_A (step S107). In a case where the number of times of calculation has reached the threshold TH_A (step S107: Yes), the optimization unit 104 ends the optimization calculation processing and returns to step S105.

In a case where the number of times of calculation has not reached the threshold TH_A (step S107: No), the optimization unit 104 determines whether or not the calculation time of the optimization calculation processing has been reached (step S108). In a case where the calculation time of the optimization calculation processing has not been reached (step S108: No), the optimization unit 104 returns to step S106 and repeats the solving processing.

In a case where the calculation time of the optimization calculation processing has been reached (step S108: Yes), the search unit 103 determines whether or not the number of searches has reached the threshold TH_B (step S109). In a case where the number of searches has not reached the threshold TH_B (step S109: No), the search unit 103 returns to step S105 and repeats the processing.

In a case where the number of searches has reached the threshold TH_B (step S109: Yes), the control unit 102 determines whether or not an elapsed time from the start of the processing has reached the specified time (step S110). The start of the processing is, for example, the start of the search processing of the first time (the start of step S103). In a case where the elapsed time has not reached the specified time (step S110: No), the control unit 102 returns to step S103 and repeats the processing.

In a case where the elapsed time has reached the specified time (step S110: Yes), the output control unit 105 outputs a processing result (step S111), and ends the information processing.

Next, an example of an effect obtained by setting a value of the calculation time of the optimization calculation processing to be smaller as the search time is earlier will be described.

Setting the value of the calculation time of the optimization calculation processing to be smaller (for example, 0.1 seconds) means setting the number of times of repetitions of the solving processing executed in the optimization calculation processing to be smaller. In contrast, setting the value of the calculation time to be larger (for example, 2.5 seconds) means setting the number of times of repetitions of the solving processing executed in the optimization calculation processing to be larger.

Depending on the optimization calculation processing to be applied, in the repeated solving processing, a speed of solution convergence may be faster in an earlier stage of the repeated solving processing, and the speed of the solution convergence may be slower in a later stage of the solving processing. Therefore, at the stage where the speed of the solution convergence is fast, the search processing is executed as many times as possible (for example, 50 times) in a short calculation time, and a rough search for an optimal value of the parameter is enabled. Furthermore, at the stage where the speed of the solution convergence is slow, the search processing is executed a smaller number of times (for example, twice) in a longer calculation time, and the optimal value of the parameter can be searched for with higher accuracy.

In the search processing for the parameter using the Bayesian optimization, it is sufficient that the evaluation values of the solutions can be compared as described above, and it is not necessary to obtain a highly accurate solution. Furthermore, in the optimization calculation processing in which the speed of the solution convergence is fast at the early stage of repetition as described above, it is possible to obtain a solution with acceptable accuracy even when the calculation time is short. Therefore, even when the calculation time of the optimization calculation processing is set to be shorter as the search time is earlier, it is possible to search for the parameter that makes it possible to obtain a more accurate solution of the optimization calculation processing.

As described above, by setting the value of the calculation time of the optimization calculation processing to be smaller as the search time is earlier, an average calculation time per one time of the search processing can be reduced without reducing the number of searches, and the value of the parameter can be searched for more efficiently.

In the example described above, the control unit 102 divides the specified time into the two search times (the first half phase and the second half phase), and sets the calculation time having the value smaller than that of the second half phase for the first half phase. Similarly, in a case where the specified time is divided into three or more times, the control unit 102 may set the value of the calculation time of the optimization calculation processing to be smaller as the search time is earlier. For example, the control unit 102 may divide the specified time into three phases of a first phase, a second phase, and a third phase in the order of the earlier time, and set the calculation time for each phase such that each of the first phase, the second phase, and the third phase has a smaller value in this order.

A method of setting the calculation time is not limited to the method of decreasing the value of the calculation time of the optimization calculation processing as the search time is earlier. For example, a method of setting the calculation time according to the speed of the solution convergence of the optimization calculation processing (solving processing) to be applied may be used. For example, the control unit 102 may set the value of the calculation time to be small for the search time (phase) corresponding to the stage where the speed of the solution convergence is fast, and may set the value of the calculation time to be large for the search time (phase) corresponding to the stage where the speed of the solution convergence is slow.

### First Modification

In a first modification, in a case where the number of times the solution is not updated by the solving processing reaches a prescribed value (for example, 100 times), the optimization unit 104 ends the optimization calculation processing even within the calculation time. By such processing, it is possible to suppress repetition of invalid solving processing and to search for the parameter more efficiently. The prescribed value may be set to a different value for each of the plurality of search times.

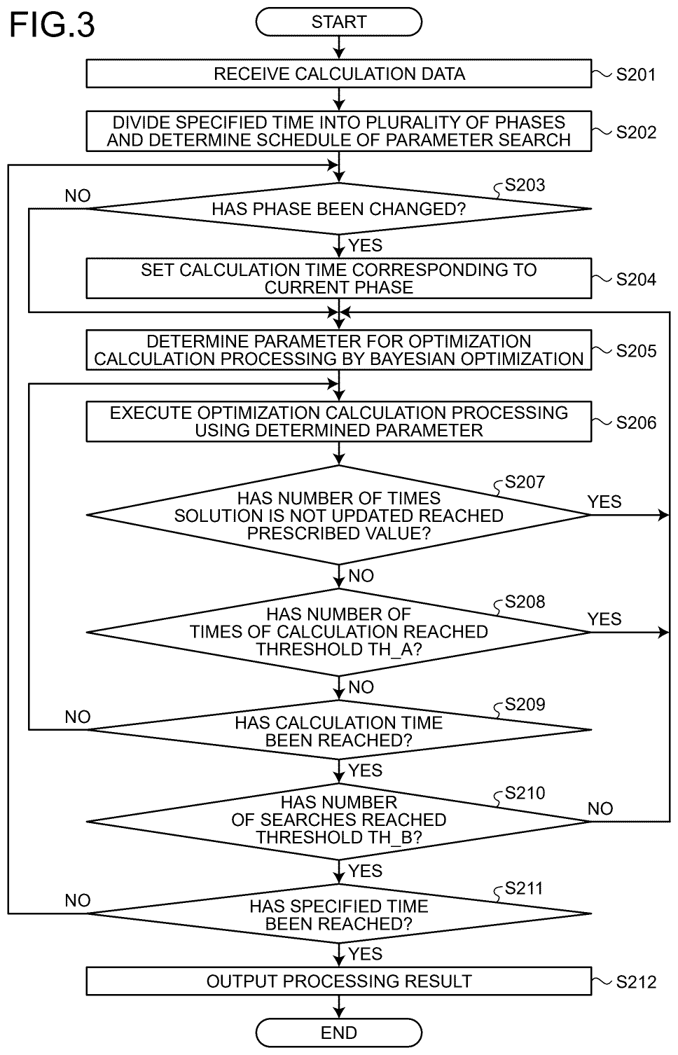

FIG. 3 is a flowchart illustrating an example of information processing in the first modification. The present modification is different from the information processing in the embodiment described above (FIG. 2) in that step S207 is added. Since processing of steps S201 to S206 is similar to the processing of steps S101 to S106 in the embodiment described above, and processing of steps S208 to S212 is similar to the processing of steps S107 to S111 in the embodiment described above, description thereof will be omitted.

The optimization unit 104 determines whether or not the number of times the solution is not updated by the solving processing has reached a prescribed value (step S207). In a case where the number of times the solution is not updated has not reached the prescribed value (step S207: No), the optimization unit 104 continues the processing of step S208 and subsequent steps. In a case where the number of times the solution is not updated has reached the prescribed value (step S207: Yes), the optimization unit 104 ends the optimization calculation processing and returns to step S205.

In this manner, in the present modification, in a situation where the solution is not updated, the optimization calculation processing (search processing) can be terminated even when the calculation time has not been reached, and the search time can be further shortened. Therefore, the number of searches can be further increased than the number of searches assumed from a length (search time) of each phase and the calculation time.

### Second Modification

The first modification has the function of ending (terminating) the optimization calculation processing according to the number of times the solution is not updated, in addition to the function of dividing the specified time into the plurality of search times (phases) and setting the calculation time for each phase (the embodiment described above). Even with only the latter function (the function of ending the optimization calculation processing according to the number of times the solution is not updated), the value of the parameter can be searched for more efficiently. In a second modification, an example having such a configuration will be described.

In the second modification, the control unit 102 does not have the function of dividing the specified time into the plurality of search times (phases), and assumes the specified time as one search time and sets a calculation time for the search time. For example, the control unit 102 sets the calculation time of one second for the specified time (search time) of 10 seconds.

The search unit 103 of the present modification causes the optimization unit 104 to execute the optimization calculation processing so as to be completed within the set calculation time. The search unit 103 of the present modification has functions similar to those of the embodiment described above except that the search processing is executed for the one search time instead of the plurality of search times.

Similarly to the first modification described above, the optimization unit 104 of the present modification further has a function of ending the optimization calculation processing even within the calculation time in a case where the number of times the solution is not updated by the solving processing reaches a prescribed value.

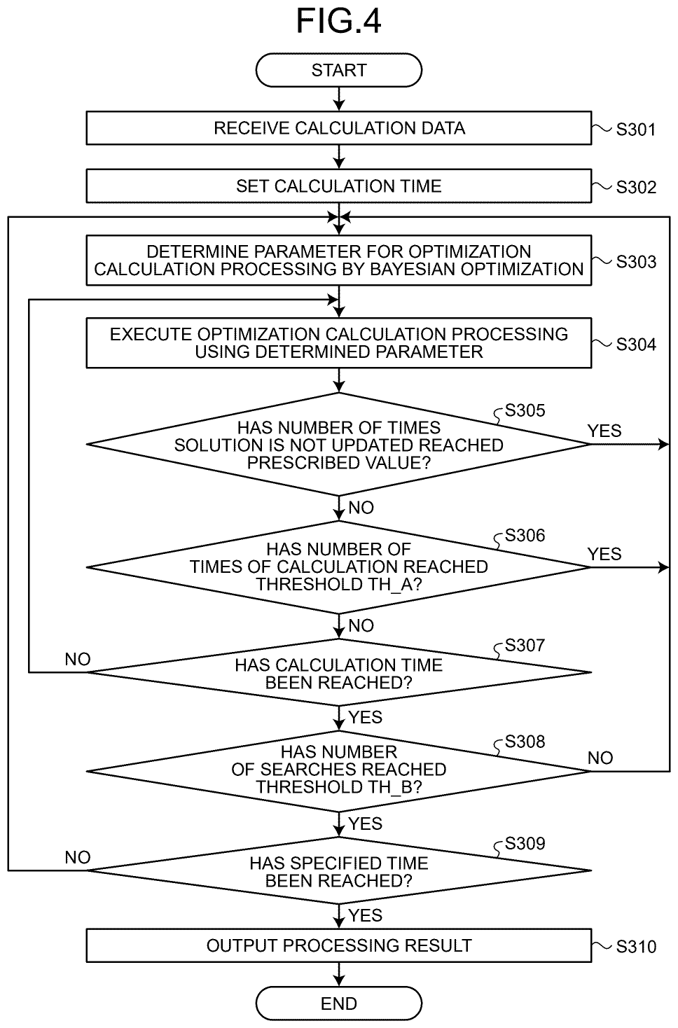

FIG. 4 is a flowchart illustrating an example of information processing in the second modification. Since processing of step S301 is similar to the processing of step S201 in the first modification, description thereof will be omitted.

In the second modification, the control unit 102 sets the calculation time for the one search time (specified time) (step S302).

Since processing of steps S303 to S308 is similar to the processing of steps S205 to S210 in the first modification, description thereof will be omitted.

In a case where the number of searches has reached the threshold TH_B (step S308: Yes), the control unit 102 determines whether or not an elapsed time from the start of the processing has reached the specified time (step S309). In a case where the elapsed time has not reached the specified time (step S309: No), the control unit 102 returns to step S303 and repeats the processing.

Since processing of step S310 is similar to the processing of step S212 in the first modification, description thereof will be omitted.

Note that, in step S305, as in step S207 of the first modification, it is determined whether or not the number of times the solution is not updated has reached a prescribed value (step S305). In a case where the prescribed value has been reached (step S305: Yes), the optimization unit 104 ends the optimization calculation processing even within the calculation time. For example, in a case where the solution converges before the set calculation time of one second (for example, 0.1 seconds), the optimization calculation processing (search processing) is terminated in the middle of the calculation time, and the number of searches can be increased accordingly.

As described above, according to the embodiment, it is possible to more efficiently search for the value of the parameter for the optimization calculation processing.

An object of the present disclosure is to provide an information processing device, an information processing method, and a computer program product capable of more efficiently searching for the value of the parameter for optimization calculation processing.

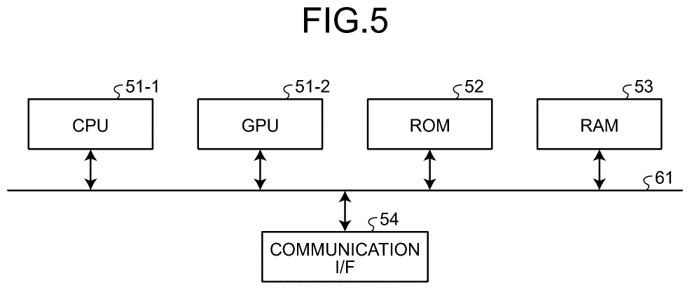

Next, a hardware configuration of the information processing device according to the embodiment will be described with reference to FIG. 5. FIG. 5 is an explanatory diagram illustrating a hardware configuration example of the information processing device of the embodiment (and the modifications).

The information processing device of the embodiment includes a control device such as a central processing unit (CPU) 51-1 and a graphics processing unit (GPU) 51-2, a storage device such as a read only memory (ROM) 52 and a random access memory (RAM) 53, a communication I/F 54 that is connected to a network and performs communication, and a bus 61 that connects the respective units. Note that the CPU 51-1 and the GPU 51-2 may be integrally provided with both functions.

A program executed by the information processing device of the embodiment is provided by being incorporated in the ROM 52 or the like in advance.

The program executed by the information processing device of the embodiment may be configured to be provided as a computer program product by being recorded as a file in an installable format or an executable format in a computer-readable recording medium such as a compact disk read only memory (CD-ROM), a flexible disk (FD), a compact disk recordable (CD-R), or a digital versatile disk (DVD).

Moreover, the program executed by the information processing device of the embodiment may be configured to be stored on a computer connected to a network such as the Internet and provided by being downloaded via the network. Furthermore, the program executed by the information processing device of the embodiment may be configured to be provided or distributed via the network such as the Internet.

The program executed by the information processing device of the embodiment can cause a computer to function as each unit of the information processing device described above. For this computer, the CPU 51-1 and the GPU 51-2 can read the program from a computer-readable storage medium onto a main storage device and execute the program.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
one or more hardware processors configured to function as:
an optimization unit that executes optimization calculation processing of obtaining an optimal solution by repeatedly executing solving processing of obtaining a solution to an optimization problem by using one or more set parameters;
a control unit that sets a calculation time of the optimization calculation processing for each of a plurality of search times obtained by dividing a specified time that is specified; and
a search unit that repeatedly executes search processing of setting the parameter different from parameters of other search times for each of the plurality of search times, causing the optimization unit to execute the optimization calculation processing within the set calculation time by using the set parameter, and searching for an optimal value of the parameter by Bayesian optimization by using the optimal solution obtained by the optimization calculation processing.

2. The information processing device according to claim 1, wherein
the control unit sets a value of the calculation time to be smaller as the search time is earlier among the plurality of search times.

3. The information processing device according to claim 1, wherein
the control unit sets, for a first search time corresponding to an early time and a second search time corresponding to a late time among two search times obtained by dividing the specified time into two, a value of the calculation time for the first search time to be smaller than a value of the calculation time for the second search time.

4. The information processing device according to claim 1, wherein
the optimization unit ends the optimization calculation processing in a case where a number of times the solution is not updated by the solving processing reaches a prescribed value.

5. The information processing device according to claim 1, wherein
the optimization unit ends the optimization calculation processing in a case where a number of times of repetitions of the solving processing reaches a first threshold.

6. The information processing device according to claim 1, wherein
the search unit ends the search processing in a case where a number of searches representing a number of times of repetitions of the search processing reaches a second threshold.

7. An information processing device comprising:
one or more hardware processors configured to function as:
an optimization unit that executes optimization calculation processing of obtaining an optimal solution by repeatedly executing solving processing of obtaining a solution to an optimization problem by using one or more set parameters; and
a search unit that repeatedly executes search processing of setting the parameter different for each time of repetition, causing the optimization unit to execute the optimization calculation processing by using the set parameter, and searching for an optimal value of the parameter by Bayesian optimization by using the optimal solution obtained by the optimization calculation processing, wherein
the optimization unit ends the optimization calculation processing in a case where a number of times the solution is not updated reaches a prescribed value.

8. An information processing method executed by a computer of an information processing device, the information processing method comprising:
executing optimization calculation processing of obtaining an optimal solution by repeatedly executing solving processing of obtaining a solution to an optimization problem by using one or more set parameters;
setting a calculation time of the optimization calculation processing for each of a plurality of search times obtained by dividing a specified time that is specified; and
repeatedly executing search processing of setting the parameter different from parameters of other search times for each of the plurality of search times, causing the optimization calculation processing to be executed within the set calculation time by using the set parameter, and searching for an optimal value of the parameter by Bayesian optimization by using the optimal solution obtained by the optimization calculation processing.

9. A computer program product having a non-transitory computer readable medium including programmed instructions stored thereon, wherein the instructions, when executed by a computer, cause the computer to execute:
optimization calculation processing of obtaining an optimal solution by repeatedly executing solving processing of obtaining a solution to an optimization problem by using one or more set parameters;
setting a calculation time of the optimization calculation processing for each of a plurality of search times obtained by dividing a specified time that is specified; and
search processing repeatedly by setting the parameter different from parameters of other search times for each of the plurality of search times, causing the optimization calculation processing to be executed within the set calculation time by using the set parameter, and searching for an optimal value of the parameter by Bayesian optimization by using the optimal solution obtained by the optimization calculation processing.
